(19) United States
(12) Patent Application Publication
(10) Pub. No.: US 2010/0156943 A1
(43) Pub. Date: Jun. 24, 2010

(54) METHOD FOR DRIVING A MATRIX VIEWING DEVICE WITH AN ELECTRON SOURCE

(75) Inventor: Denis Sarrasin, Sassenage (FR)

Correspondence Address: PEARNE & GORDON LLP, 1801 EAST 9TH STREET, SUITE 1200, CLEVELAND, OH, 44114-3108, US

(73) Assignee: COMMISSSARIATE A L'ENERGIE ATOMIQUE, Paris (FR)

(21) Appl. No.: 12/296,235

(22) PCT Filed: Apr. 12, 2007
(86) PCT No.: PCT/EP2007/053551

§ 371 Date: Oct. 6, 2008

(30) Foreign Application Priority Data
Apr. 14, 2006 (FR) 06 03413

(51) Int. Cl. G09G 5/10; G09G 3/20

(52) U.S. Cl. 345/690; 345/55

(57) ABSTRACT

A method for driving a matrix viewing device displaying grey levels comprising a source of electrons at the crossing of line and column electrodes, consisting of applying a line selection voltage (Vls) on the line electrode and a voltage corresponding to the grey level on the column electrode. The grey levels are distributed into two families (F1), the first grouping the darkest grey levels, the second (F2) grouping the least dark grey levels. If the grey level belongs to the first family (F1), the voltage is pulse-width-modulated, if it belongs to the second family, the voltage is amplitude-modulated. The amplitude of the pulse-width-modulated voltage and the maximum amplitude of the amplitude-modulated voltage are reduced relatively to those required if the control was performed for all the grey levels by amplitude modulation or by pulse width modulation.

### TECHNICAL FIELD

The present invention relates to a method for driving a matrix viewing device provided with one or more electron sources capable of displaying images with different grey levels. The images to be displayed may be in black and white or in color, in the latter case, the expression <<grey level>> means a color halftone.

### STATE OF THE PRIOR ART

These viewing devices with electron sources find applications in the field of flat viewing screens. There are various types of these viewing devices depending on the nature of their electron sources. For instance, field effect microtip cathodes as described in document [1], the references of which are found at the end of the description, field effect nanocrack sources as described in the document referenced as [2], carbon nanotube field effect sources as described in the document referenced as [3], are known.

FIG. 1 schematically illustrates the operating principle of an exemplary viewing device with field effect electron sources to which the method of the invention may be applied.

The viewing device includes electron sources 100 including anode electrodes 1 covered with luminophoric material 2, cathode electrodes 3 electrically connected to electron-emitting areas 4, gate electrodes 5, electrically insulated from the cathode electrodes 2. Each emitting area 4 is associated with a gate electrode 5. A vacuum 6 prevails between the emitting areas 4 and the luminophoric material 2.

The device relative to controlling electron sources 100 includes a voltage source 7 and biasing means 8. With the voltage source 7, a high voltage Va may be applied to the anode electrodes 1. With the biasing means 8 for a given source of electrons 100, it is possible to apply a potential Vg on the gate electrode which is associated with it and a potential Vc1, Vc2, Vc3 on the cathode electrode 3 to which it is connected. The potential difference Vgc1, Vgc2, Vgc3, generally called Vgc in the following, represents the voltage for controlling electron emission.

A source of electrons 100 emits a flow of electrons (not shown) from its emitting area 4 and this flow of electrons is collected by an anode electrode 1 which faces the emitting area when the potential difference Vgc exceeds a threshold value Vthl. This flow of electrons is accelerated by the high voltage Va applied to the anode electrodes 1. The luminophoric material 2 emits light under the effect of the kinetic energy of the electrons with which it is bombarded. FIG. 2 illustrates an emission characteristic Ia=f(Vgc) of an electron source 4.

A problem encountered in these viewing devices is that the emitting areas are not uniform in terms of emission, some of them are very performing and emit more than others for a same control voltage. This is expressed at the luminophoric material on the anode electrode side by a not very homogenous image and studded with bright points. In the document referenced as [1] or in the document referenced as [4], it is indicated that an effective means for homogenizing the emission consists of submitting the most performing electron sources to an adverse effect in order to bring back their emission to a lesser level. This is generally achieved by placing a resistor R1 in series between the emitting area 4 and the cathode electrode 3 which is connected to it. A potential difference proportional to the current which flows through the electron source is then subtracted from the potential difference Vgc, which limits the emission current. This resistor may be embodied by a layer of resistive material which covers the cathode electrodes. FIG. 3 illustrates such a configuration. The gate electrodes 5 are electrically insulated from the cathode electrodes 3 by a layer of dielectric material 9. In FIG. 3, the cathode electrode 3 lies on an electrically insulating substrate 110.

The viewing device may have a screen 17 arranged as a matrix as illustrated in FIG. 4 with one or more sources of electrons 4. Each electron source 4 represents a pixel Pi,j of the screen. Each pixel Pi,j may be addressed and its luminance adjusted as described in the document referenced as [5]. Each pixel Pi,j is defined as the crossing between a line electrode L1, . . . Li, . . . Ln and a column electrode C1, . . . Cj, Cm of the viewing device 17. There are generally several line electrodes and several column electrodes. The line electrodes L1, . . . Li, . . . Ln are generally connected to the gate electrodes and the column electrodes C1, . . . Cj, . . . Cm to the cathode electrodes. However it will be noted that the viewing device 17 may be reduced to a single source of electrons or a single pixel if only one line electrode and one column electrode are available or be in the form of a linear array if it only has a single line electrode or a single column electrode.

A control device is provided for controlling the viewing device with a line sweep generator 10 connected to a voltage source 11 delivering a voltage Vls and to a reference voltage Vlns, generally the ground, so that it may apply on the line electrodes either the line selection voltage Vls or the reference voltage Vlns i.e. the line non-selection voltage. The control device further includes a circuit 12 for controlling the columns connected to a voltage source 13 delivering a voltage Vcj and to a reference voltage Vcom which may be the ground. The line sweep generator 10 and the column control circuit are connected to a screen controller 14 which receives signals from a data source (not shown), control and synchronization signals and which delivers signals capable of controlling the line sweep generator 10 and the column control circuit 12. As for the anode electrodes 1, there are connected to a voltage source 15 delivering a voltage Va.

More specifically, the line sweep generator includes an addressing circuit for each line electrode. In the same way, the column control circuit includes a subcircuit for each column electrode. Control of the screen is carried out in the following way: the line electrodes L1, Ln are sequentially addressed one at a time during a line selection period T1. An addressed line electrode is set to the voltage Vls and a non-addressed line electrode is set to the voltage Vlns. The pixels of an addressed line electrode Li should each display a given piece of information and each column electrode Cj is set to a suitable voltage Vcj. The applied voltages on the column electrodes do not affect the pixels of the non-addressed line electrodes L1, Li−1, li+1, Ln. In order to obtain grey levels, it is possible to act on the values of the differences Vls-Vcj and/or on the duration of application of the voltage Vcj or even on the amount of charges provided to the column electrodes and corresponding to the information to be displayed.

As indicated earlier, several methods for controlling the columns of viewing devices displaying grey levels are encountered and these methods all suffer from drawbacks.

Pulse width modulation control (PWM) consists of applying a fixed voltage Vc to the column electrodes during a variable time depending on the grey level to be displayed, this variable time being less than or equal to the line selection period T1. Pulse width modulation control maximizes switchings between the voltage Vc and the voltage Vcom, which induces strong capacitive consumption.

Amplitude modulation control is carried out by applying during the whole line selection period T1, onto the column electrodes, a voltage Vc(k), the value of which depends on the grey level to be displayed, this value being comprised between Vc(k)max and Vcom. Consumption is minimized but it leads to low level display inhomogeneities. Indeed, homogenization by a resistive layer as illustrated in FIG. 3 is satisfactory for a high column electrode/line electrode (or gate cathode) potential difference corresponding to white or close-to-white emission. The effect of this layer is quasi zero at low level for black or close-to-black emission. It was demonstrated both from the experimental point of view and from the theoretical point of point, that the uniformity of the display of carbon nanotube field effect devices as described in the document referenced as [6], is deteriorated when the column electrode/line electrode potential difference decreases.

In viewing devices controlled in a mixed way, several voltage levels are applied to the column electrodes during the line selection period. The document referenced as [7] describes such a control method. This control method suffers from the same defect of lack of uniformity at a low level of the column electrode/line electrode potential difference as the amplitude modulation control mode.

The charge control method, described for example in the document referenced as [8], tries to provide column electrodes with an amount of charges corresponding to the grey level to be displayed. This control method additionally requires rather complex circuits of screens which do not have or practically do not have any leak currents.

Patent Application US 2002/0060525 describes a method for driving a matrix viewing device displaying grey levels wherein the grey levels are distributed into two families of grey levels, the first corresponding to the darkest grey levels and the second corresponding to the least dark grey levels. If the grey level to be displayed belongs to the first family, a control voltage applied to the columns which is pulse-width-modulated, is used. If the grey level to be displayed belongs to the second family, a control voltage applied to the columns which is amplitude-modulated, is used. Both of these control voltages vary in the same direction between a reference voltage and a maximum voltage. On the other hand, both of these control voltages vary in an opposite direction with respect to the existing direction of variation between the line non-selection voltage and the line selection voltage.

### DISCUSSION OF THE INVENTION

The object of the present invention is precisely to propose a method for driving a viewing device which does not have the aforementioned drawbacks.

More particularly, an object of the present invention is to propose a driving method which limits capacitive consumption and which leads to good homogeneity of the displayed image both at a high level and at a low level, notably in the case when a resistive layer is present between the cathode electrodes and the emitting areas.

To achieve this, the present invention proposes a method for driving a matrix viewing device displaying grey levels, comprising at least one source of electrons located at the crossing of a line electrode and of a column electrode, consisting of applying a line selection voltage, when the line electrode on which is found the source of electrons is selected, and a line non-selection voltage when it is not selected, and of applying on the corresponding column electrode a control voltage corresponding to the grey level to be displayed, during a line selection period Tl. The grey levels to be displayed are distributed into two families of grey levels, the first grouping one or more of the darkest grey levels, the second grouping one or more of the least dark grey levels. If the grey level to be displayed belongs to the first family, the control voltage to be applied is a pulse width modulated voltage varying between a reference voltage and an extreme voltage, the direction of variation between the reference voltage and the extreme voltage being the same as between the line non-selection voltage and the line selection voltage. The extreme voltage is positive relative to the reference voltage. If the grey level to be displayed belongs to the second family, the control voltage to be applied is an amplitude-modulated voltage varying between the reference voltage and a maximum voltage, the direction of variation between the reference voltage and the maximum voltage being opposite to that existing between the line non-selection voltage and the line selection voltage, the extreme voltage and the maximum voltage being reduced relatively to those which would be required if the control was performed for all the grey levels by amplitude modulation or by pulse width modulation. The maximum voltage is negative relative to the reference voltage.

If the grey level to be displayed belongs to the first family, the control voltage during a first time interval T 0<T≦Tl, is the extreme voltage which is constant and insofar that the first time interval is strictly less than the line selection period, the control voltage during a second time interval T′=Tl−T preceding or following the first time interval T, is the reference voltage, the value of the first time interval T depending on the grey level to be displayed. If the grey level to be displayed belongs to the second family, the control voltage during the whole line selection period, is a constant voltage negative relative to the reference voltage or equal to the reference voltage, this control voltage having an amplitude which depends on the grey level to be displayed.

The line selection voltage is preferably constant during the whole line selection period.

If several sources of electrons are on a same line electrode, the method preferably consists of applying a control voltage simultaneously on each of the column electrodes relative to its sources of electrons.

The method consists of preferably applying a line non-selection voltage to a non-selected line electrode during the whole line selection period.

It is preferable that the extreme voltage and the maximum voltage be substantially equal in absolute value.

The reference voltage may correspond to the ground.

The present invention relates to a viewing device controlled by the thereby defined control method, wherein the source of electrons includes a resistor between an electron emitting area and a cathode electrode electrically connected to the line electrode.

The present invention also relates to a device for driving a matrix viewing device displaying grey levels, comprising at least one source of electrons located at the crossing of a line electrode and of a column electrode of an assembly including one or more line electrodes and one or more column electrodes. The device includes a line sweep generator for applying a line selection voltage during a line selection period, when the line electrode on which is found the source of electrons is selected, and a line non-selection voltage when it is not selected,

and a column control circuit capable of applying on the corresponding column electrode a control voltage corresponding to the grey level to be displayed, during the line selection period. The column control circuit includes for each column electrode of the assembly, a first processing chain in order to deliver a pulse-width-modulated control voltage to be applied onto the column electrode, if the grey level belongs to a first family of grey levels containing one or more of the darkest grey levels, the pulse-width-modulated control voltage varying between a reference voltage and an extreme voltage, the direction of variation between the reference voltage and the extreme voltage being the same as between the line non-selection voltage and the line selection voltage.

The device includes a second processing chain in order to deliver an amplitude-modulated control voltage to be applied onto the column electrode, if the grey level belongs to a second family of grey levels containing one or more of the least dark grey levels, the amplitude-modulated control voltage varying between the reference voltage and a maximum voltage, the direction of variation between the reference voltage and the maximum voltage being opposite to the one existing between the line non-selection voltage and the line selection voltage. The extreme voltage and the maximum voltage are reduced relatively to those which would be required if the control was performed for all the grey levels by amplitude modulation or by pulse width modulation.

The first processing chain may include means for delivering, from information encoding the grey level to be displayed which they receive, a signal which expresses an instant of the beginning or of the end of the pulse-width-modulated voltage pulse in the line selection period, if the grey level belongs to the first family of grey levels, these means being connected via means for matching logic levels to an output stage capable of delivering the pulse-width-modulated voltage.

The means for delivering the signal expressing the instant of the beginning or of the end of the pulse of the pulse-width-modulated voltage may include a comparator comparing the information encoding the grey level and the result of a count performed by a cyclic counter counting a number of clock pulses determined by the size of the information encoding the grey level, during the line selection period, and a flip-flop connected to the output of the comparator and also receiving a cue at the beginning of each line selection period and delivering the signal expressing the instant of the beginning or of the end of the pulse-width-modulated voltage pulse.

The device for driving the viewing device may include a negative ramp generator with which the amplitude-modulated voltage may be provided and the second processing chain may include means for delivering, from information encoding the grey level which they receive, a signal which expresses a sample hold instant of the negative ramp generator in a line selection period, if the grey level belongs to the second family of grey levels, these means controlling analog memory storage means having an input connected to the negative ramp generator and an output connected to the input of a buffer amplifier capable of delivering the amplitude-modulated voltage.

The means for delivering the signal expressing the sample hold instant of the negative ramp generator may include a comparator comparing the information encoding the grey level and the result of a count performed by a cyclic counter counting a number of clock pulses determined by the size of the information encoding the grey level, during the line selection period, and a flip-flop connected to the output of the comparator and also receiving a cue at the beginning of each line selection period and delivering the signal expressing the sample hold instant of the negative ramp generator.

In order to simplify the device, the cyclic counter may be common to the first and to the second processing chain.

The analog memory storage means may include a switch connected on one side to the negative ramp generator and on the other side to a terminal of a capacitor itself connected to the input of the buffer amplifier, the other terminal of the capacitor being set to a reference voltage, this switch being controlled by the signal expressing the sample hold instant of the negative ramp generator. The reference voltage to which is set the other terminal of the capacitor is generally the ground in practice.

The column control circuit may further include, per column electrode, means for selecting the first processing chain or the second processing chain depending on the grey level to be displayed on the column electrode.

In the viewing device, the grey level to be displayed is encoded as a binary word with one or more high order bits, the selection means preferably being combinatorial circuits receiving the high order bits of the binary word.

The circuit for controlling the columns may further include a shift register which drives as many sets of memory latches as there are column electrodes, each set of memory latches receiving at the input the grey levels to be displayed by the viewing device and being connected to a first processing chain and to a second processing chain.

Each set of memory latches may also be connected at the output to the input of the selection means.

### SHORT DESCRIPTION OF THE DRAWINGS

The present invention will be better understood upon reading the description of given exemplary embodiments, purely as an indication and by no means as a limitation, with reference to the appended drawings wherein:

FIG. 1 (already described) illustrates a field effect electron source viewing device to which the method of the invention may be applied;

FIG. 2 (already described) is a graph illustrating the emission characteristic Ia=f(Vgc) of a source of electrons;

FIG. 3 (already described) illustrates sources of electrons provided with a layer in a resistive material which covers their cathode electrodes;

FIG. 4 (already described) illustrates a viewing device equipped with its standard control device;

FIGS. 5A, 5B are time diagrams of the voltage signals respectively applied to the line and column electrodes of a viewing device driven by the method of the invention;

FIGS. 6A, 6B are time diagrams of voltage signals respectively applied to the line and column electrodes of a viewing device driven by a standard method;

FIG. 7 illustrates the voltage signals to be applied to line and column electrodes of a viewing device driven by the method of the invention and capable of displaying 8 grey levels;

FIG. 8A illustrates the device for driving a viewing device according to the invention, FIG. 8B illustrates an example of a circuit for controlling common electrodes of a viewing device according to the invention, FIG. 8C illustrates the voltage delivered by the negative ramp generator of the circuit of FIG. 8A;

FIG. 9 partly illustrates another example of a circuit for controlling the column electrodes of a viewing device according to the invention.

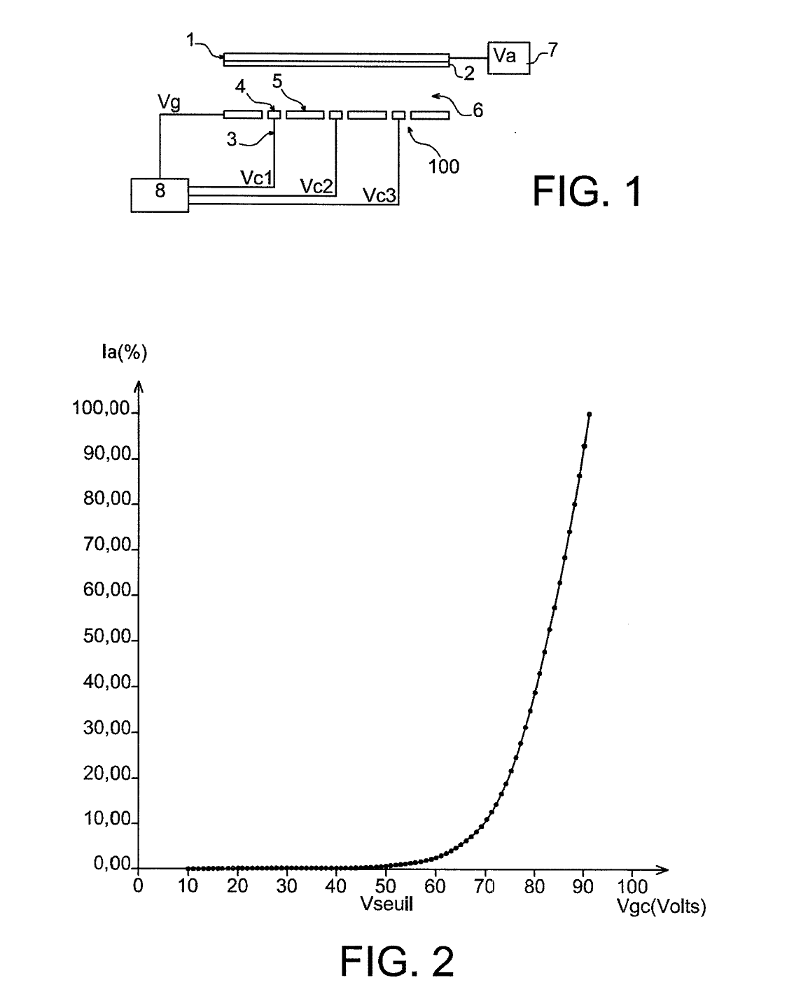

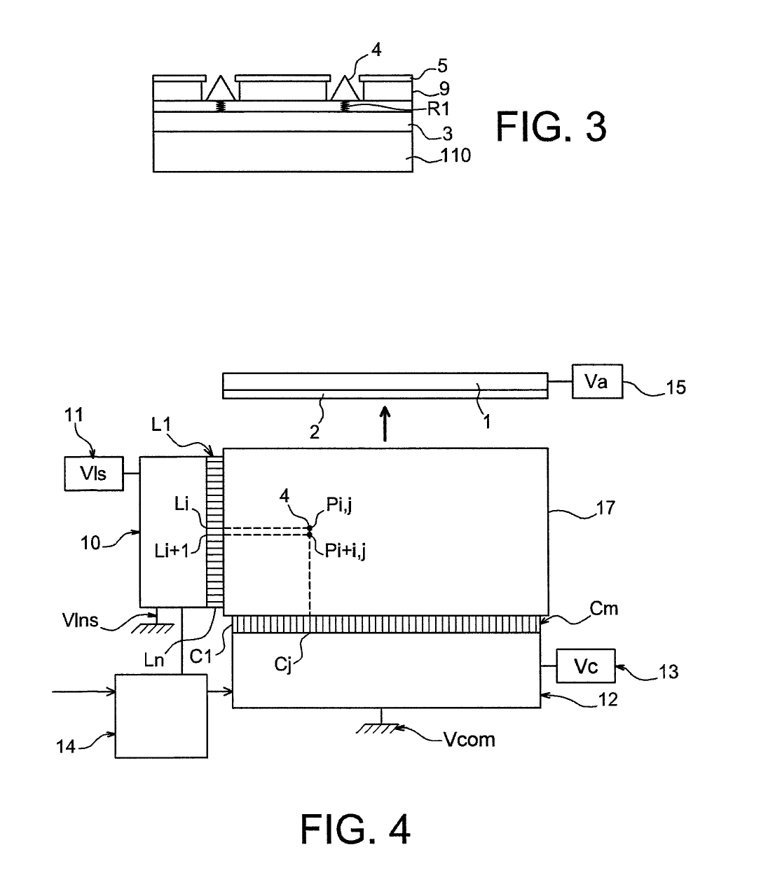

The different illustrated and described alternatives should be understood as not being exclusive from each other.

Well-known structures are not illustrated in detail in order not to unnecessarily encumber the present invention.

Identical, similar or equivalent portions of the different figures described hereafter bear the same numerical references so as to facilitate the passing from one figure to the other.

The different portions illustrated in the figures are not necessarily illustrated according to a uniform scale, in order to make the figures more legible.

### DETAILED DISCUSSION OF PARTICULAR EMBODIMENTS

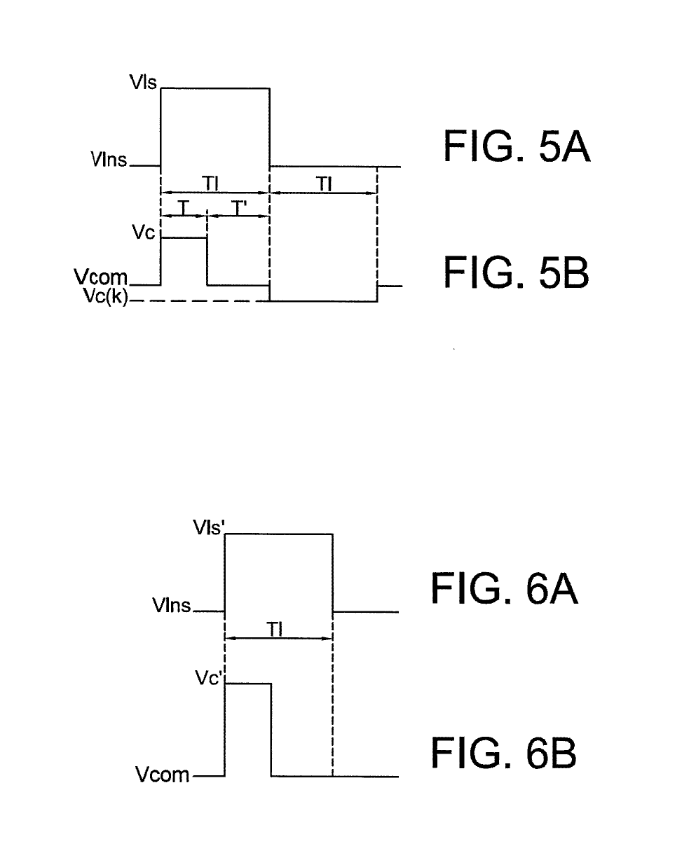

We shall now be concerned with the method for driving a viewing device capable of displaying n grey levels according to the invention. This viewing device may be similar to the one described in FIG. 4 to which reference may be made. It includes at least one source of electrons 4 materializing a pixel Pi,j. This source of electrons 4 includes an electron-emitting area located at the crossing of a line electrode Li and of a column electrode Cj. Subsequently, it will be acknowledged that the source of electrons is located at the crossing of a line electrode and of a column electrode. The control method according to the invention consists of selecting, each in turn, the line electrodes L1, Li, Ln and of applying to each selected line electrode during a line selection period Tl, a line selection voltage Vls, a non-selected line electrode receiving a line non-selection voltage Vlns, for example the ground. Reference may also be made to FIG. 5A which shows the signal applied on a given line electrode Li during two successive line selection periods Tl, the line electrode Li only being selected during the first period Tl. During the second line selection period Tl, it is assumed that the line electrode Li+1 is the one which will be selected. The line selection voltage Vls is applied on the line electrode Li during the first line selection period Tl and the line non-selection voltage Vlns is applied to it during the second period Tl. Such a control of line electrodes is standard. For all intents and purposes, FIG. 6A illustrates the conventional signal to be applied on a selected line electrode in the case of pulse width modulation or of amplitude modulation. It is noted that the amplitude of the voltage Vls′ is larger than that of the voltage Vls.

It is assumed that the viewing device is capable of displaying n (n is an integer larger than or equal to three) grey levels, these grey levels being encoded between 0 and n−1. Code 0 corresponds to black and code n−1 to white. The n grey levels will be arbitrarily distributed into two families of grey levels, i.e. a first family F1 of the darkest greys and a second family F2 of the least dark greys. The first family F1 includes p grey levels (p is an integer strictly less than n), these p grey levels being encoded between 0 and p−1. The level p−1 corresponds to the palest grey level of the first family F1 of the darkest greys. The second family F2 of grey levels includes n−p grey levels encoded between level p and level n−1. Level p corresponds to the darkest grey level of the second family F2 of the palest greys.

As regards the column electrode control, pulse width modulation will be used for displaying the grey levels of the first family F1 and amplitude modulation for displaying the grey levels of the second family F2. The pulse-width-modulated control voltage varies between a reference voltage Vcom and an extreme voltage Vc. The direction of variation existing between Vcom and Vc is the same as the one existing between Vlns and Vls.

The amplitude of the pulse-width-modulated voltage is less than the one which would be required if, for all the grey levels to be displayed, the control was performed by pulse width modulation.

The amplitude-modulated control voltage varies between the reference voltage and a maximum voltage Vc(k3). The direction of variation existing between Vcom and Vc(k3) is the opposite of the one existing between Vlns and Vls.

In the same way, the maximum amplitude of the amplitude-modulate voltage is less than the one which would be required if, for all the grey levels to be displayed, the control was performed by amplitude modulation. The required voltage corresponds to the one required for passing from black to white. In other words, the difference between the amplitude of the pulse-width-modulated voltage and the maximum amplitude of the amplitude-modulated voltage is substantially equal to the one which would be required for displaying all the grey levels, if the control was performed exclusively by pulse width modulation or exclusively by amplitude modulation.

Reference will now be made to FIG. 5B which shows the aspect of the voltage signal to be applied for controlling a column electrode Cj. In this situation, a grey level of the first family F1 is intended to be displayed on the pixel Pi,j located at the crossing of this column electrode Cj and of the line electrode Li receiving the signal of FIG. 5A on the one hand, and a grey level of the second family F2 is intended to be displayed on a pixel Pi+1,j located at the crossing of this column electrode Cj and of the line electrode Li+1 which immediately follows the line electrode Li concerned by FIG. 5A on the other hand.

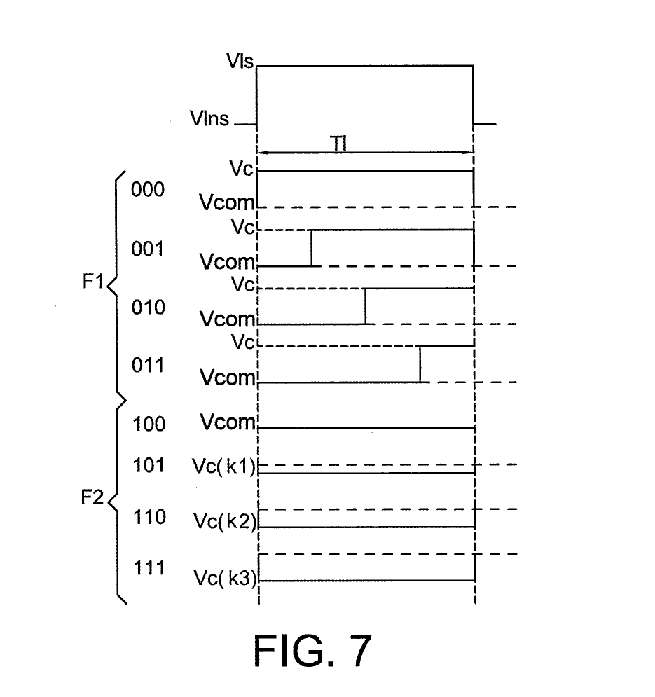

We shall begin by describing the voltage signal applied during the first line selection period T1 to the column electrode Cj. The extreme voltage Vc, constant and positive relative to the reference voltage Vcom is applied on this column electrode Cj during a first time interval T with 0<T≦Tl. Insofar that the first time interval T is strictly less than the line selection period T1 (T<Tl), the reference voltage Vcom, is applied to the column electrode Cj during a second time interval T′=Tl−T, preceding or following the first time interval T, the value of the first time interval T depending on the grey level to be displayed. The first time interval T may precede the second time interval T′ as in FIG. 5B. Of course, it may be contemplated that it is subsequent to it as this will be seen in FIG. 7. With the method of the invention, the greys of the first family F1, i.e. the darkest greys, are displayed in the pulse width modulation mode and the voltage swing for passing, in the first family F1 of grey levels, from one extreme grey level to the other extreme grey level, is reduced relatively to that which would be required for displaying all the grey levels by pulse width modulation. For this purpose, reference may be made to FIG. 6B which shows the voltage signal to be applied onto the column electrode in the case of conventional pulse width modulation, the amplitude of this voltage being substantially twice as large as that of FIG. 5B. In a line selection period T1, p different values for the first time interval T are therefore provided, each of these p values corresponding to one of the p grey levels of the first family F1 of grey levels. With this method, by only using a portion of the voltage swing, which would be required in the prior art, uniformization of the display of a device having a resistor between the cathode electrode and the emitting area, is achieved even for the darkest grey levels.

If the intention is now to display on pixel Pi+1,j a grey level from the second family of grey levels F2, a constant voltage Vc(k) is applied on this column electrode during the whole second line selection period T1, this voltage Vc(k) is negative relative to the reference voltage Vcom or is equal to the reference voltage Vcom. The amplitude of this voltage Vc(k) depends on the grey level to be displayed belonging to the second family F2 of grey levels. Thus, n-p voltages Vc(k) are provided, corresponding to the n-p grey levels of this second family F2 of grey levels. The voltage Vc(k3) is the one which has the largest amplitude in absolute value in FIG. 7.

An example for displaying a grey level taken from 256 grey levels with the method of the invention will be given. It is assumed that this grey level is included in the first family F1 of grey levels which includes 128 grey levels and that the value of the voltage Vc has the value +20 Volts relative to the reference voltage Vcom which has the value 0V. The line selection period T1 will be divided into 128 equal time intervals. A single pulse of amplitude 20 Volts and with a duration T equal to r time intervals, with r comprised between 1 and 128 will have to be generated. With a standard pulse width modulation method, the voltage Vc would have been equal to +40 Volts and the line selection period would have been divided into 256 equal time intervals. A single pulse of amplitude 40 Volts and with a duration equal to r′ time intervals with r′ comprised between 1 and 256 would have been generated.

The capacitive switching consumption of such a viewing device is expressed for one pixel, by C=P/V²F with P being the consumed power, V the voltage Vc and F the switching frequency. This capacitive consumption is divided by four in the case of the method of the invention as compared with the standard pulse width modulation method since the voltage was divided by two. Another advantage of the method of the invention as compared with the standard pulse width modulation method, is that by using two families of grey levels it is possible to reduce the number of time intervals to be handled during the line selection period, which amounts to stating that the cutoff frequency is increased accordingly.

As regards the second family of grey levels, by continuing with the same example, the maximum amplitude of the voltage to be switched is now −20 Volts whereas it would have been −40 volts with a standard amplitude modulation method. 128 values of potentials will now be available, between 0 and −20 Volts if Vcom has the value 0 Volt. The capacitive consumption is thereby reduced to a maximum since according to the grey levels the voltages are reduced and further there is no switching inside the line selection period.

A most vivid example is given in FIG. 7 which for a display with 8 grey levels, shows the voltage signals to be applied on a column electrode in order to obtain each of these levels. The first time diagram, for the record, shows the voltage signal applied on a line electrode of the screen of the viewing device. It is assumed that the eight grey levels are distributed in two families F1, F2 with four levels each. The first family F1 includes black and the darkest greys encoded as binary numbers 000, 001, 010, 011 respectively. The second family F2 includes the least dark greys and white encoded as binary numbers 100, 101, 110, 111 respectively. When the first family F1 is considered, the time interval T during which the column electrode is set to a positive voltage Vc relative to the reference voltage Vcom, precedes the time interval T′ during which the column electrode is set to the reference voltage Vcom. For displaying the grey levels of the second family F2, three different voltages were used, referenced as Vc(k1), Vc(k2), Vc(k3) in addition to the reference voltage Vcom. These three voltages Vc(k1), Vc(k2), Vc(k3) are negative relative to the reference potential Vcom.

In the present invention, the voltage applied on the columns in the case of grey levels from the second family F2 (for which the control is an amplitude modulation) is added to the line selection voltage at a selected pixel. The applied voltage on the columns, in the case of the grey levels from the first family F1 (for which the control is a pulse width modulation) is subtracted from the line selection voltage at a selected pixel.

This was not the case in the Patent Application US 2002/0060525. In every case, the control voltages applied on the columns are added to the line selection voltage for creating the potential difference allowing emission of electrons. The result of this is that during the line non-selection time, i.e. during 1,079 lines out of 1,080, for a full high definition (HD) screen, the line/column potential difference is equal to the control voltage of the columns if the line non-selection voltage is 0V.

Now, the emission threshold of a field effect source is more defined by a contrast or emission current ratio than by a well marked value. Indeed, the emission varies according to the following Fowler-Nordheim exponential law:

Ip=A×V²×Exp(−B/V) wherein Ip represents the emitted current, V is the gate/cathode voltage, A and B are quantities depending on technological parameters. In Patent Application US 2002/0060525, the selected threshold is the line selection voltage. If the column control voltage assumes the same value, a current contribution is available equal to that selected for the threshold for the pixels of each non-selected line displaying this voltage, whence a leak may be multiplied by more than 1,000 for a full high definition screen, i.e. of the order of magnitude of the expected contrast.

The darkest grey levels of a given pixel depend on the voltages exhibited on its column for displaying the other pixels of its column during a frame time. Accordingly, either the control voltage to be applied to the columns, which may be modulated, is drastically limited and consequently the current swing between black and white and so the contrast of the screen, or the darkest grey levels are degraded and vary depending on the image. In the invention, the palest grey levels may be displayed by providing a control voltage to the columns, which is reduced for the non-selected lines, while limiting the switching amplitude for displaying the darkest grey levels and therefore capacitive consumption.

On the whole of FIG. 2, where the threshold has the value 48 Volts and the gate column voltage Vgc for displaying white has the value 90 Volts, the following values would be obtained approximately:
for the method described in the Patent Application US 2002/0060525

Vls=48 Volts

Vlns=0 Volt

Vc=0 Volt (black)

Vc(k3)=−42 Volts (white)
for the method of the invention:

Vls=48+21=69 Volts

Vlns=0 Volt

Vc=21 Volts (black)

Vc(k3)=−21 Volts (white).

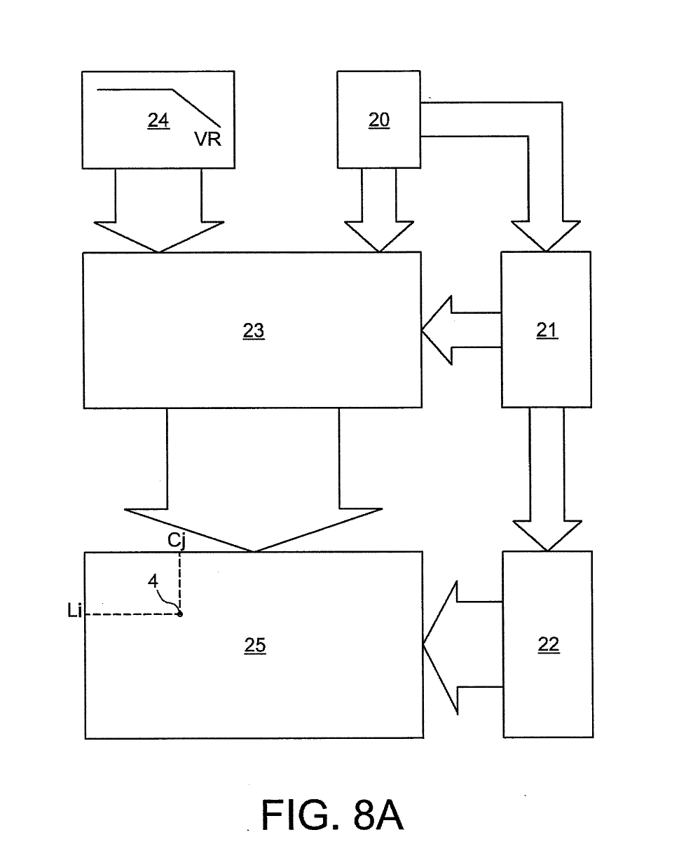

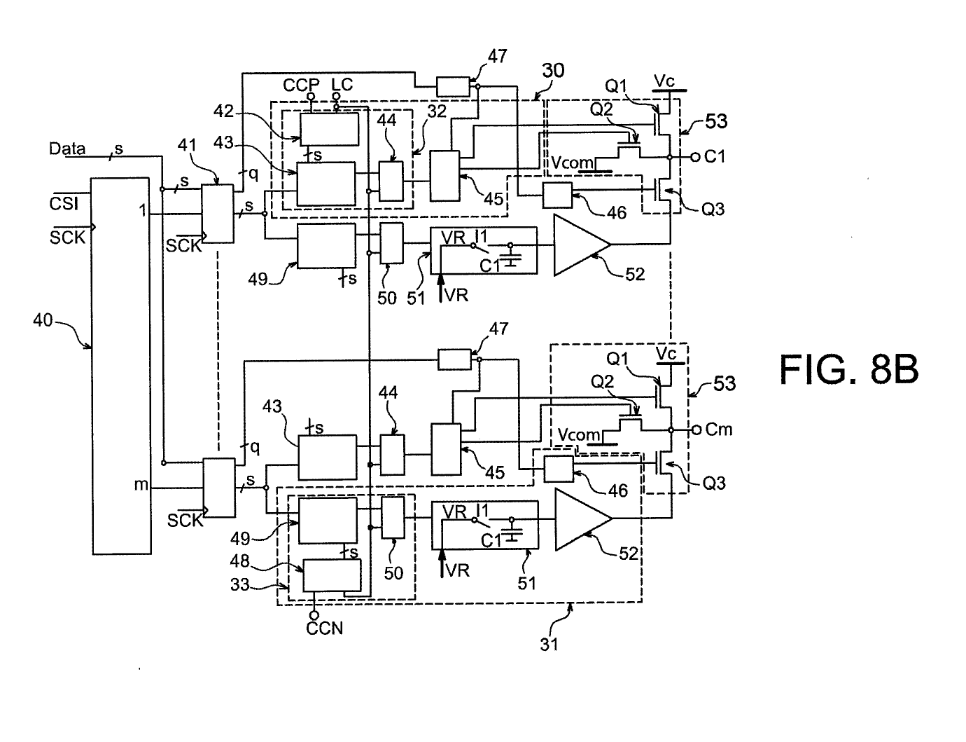

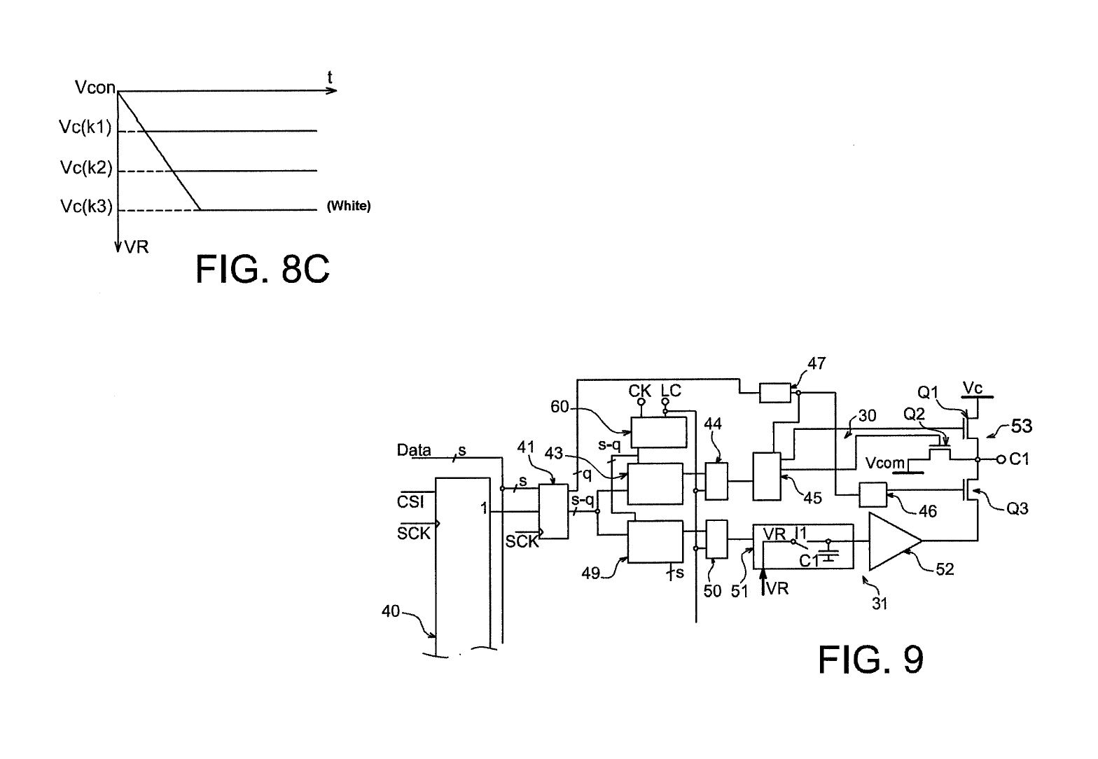

The present invention also relates to a device for driving a matrix viewing device with a source of electrons, capable of displaying grey levels. Reference is made to FIGS. 8A and 8B. The device for driving a matrix viewing device 25 with an electron source with which grey levels may be displayed according to the invention, is schematically illustrated in FIG. 8A. The viewing device 25 includes at least one source of electrons Pi,j located at the crossing of one line electrode on the one hand and of column electrode on the other hand, this line electrode and this column electrode being part of an assembly of one or more lines and of one or more columns. The source of electrons Pi,j materializes a pixel. The device for controlling the viewing device conventionally includes a sweep generator for one or more lines 22 and a circuit for controlling one or more columns 23. The circuit for controlling columns 23 is connected to a source of digital data 20 capable of providing binary words encoding over s bits, the grey level to be displayed by a pixel. The device for controlling the viewing device also includes a screen controller 21 and a ramp generator 24 with a negative slope. The screen controller 21 receives synchronization signals from the data source 20, it handles and provides signals able to drive the line sweep generator 22 and the circuit for controlling the columns 23. The negative ramp generator 24 is connected to the circuit for controlling the columns 23, the latter being able to carry out for a given column a sample and hold of a voltage VR of this negative ramp in order to then apply it to the associated column electrode. The delivered voltages VR are negative relative to the reference voltage Vcom or equal to the latter. Reference may be made to FIG. 8C which schematically shows the aspect of the VR voltage delivered by the negative ramp generator 24 and the different voltage levels which may be obtained for displaying the grey levels of the second family F2 of grey levels during a sample and hold. This figure is based on the example of FIG. 7 for which three grey levels corresponding to the voltages Vc(k1), Vc(k2), Vc(k3) should be available.

The line sweep generator 22 is conventional and it will not be described more in detail as this does not pose a problem to one skilled in the art.

An exemplary embodiment of a circuit for controlling columns will now be shown in detail with reference to FIG. 8B.

The circuit for controlling the columns includes a shift register 40 acting as an address decoder. This shift register 40 has m outputs and propagates m times the selection bit CSI by means of the clock signal SCK. The m outputs of the shift register 40 drive as many assemblies 41 of memory latches as there are column electrodes C1-Cm, each of them cooperating with one of the column electrodes C1-Cm of the viewing device 25 illustrated in FIG. 8A. If the n grey levels to be displayed are encoded by words of s bits with s=2ⁿ, the assemblies 41 include s memory latches. These assemblies 41 of memory latches also receive data words encoding the information to be displayed, delivered by the source of digital data 20 which they store in memory with the clock signal SCk when the shift register 40 validates said assembly 41 of memory latches.

The output of each of the m assemblies 41 of memory latches drives a first processing chain 30 aiming at delivering the voltage control signal to be applied onto the associated column electrode when the grey level to be displayed belongs to the first family F1 of grey levels on the one hand and a second processing chain 31 aiming at delivering the voltage control signal to be applied onto the associated column electrode when the grey level to be displayed belongs to the second family F2 of grey levels on the other hand. The outputs of these first and second processing chains 30, 31 are connected to a column electrode C1-Cm which is the associated column electrode. The output of each of the m assemblies 41 of memory latches is also connected to the input of selection means 47 either of the first processing chain 31 or of the second processing chain 31 depending on the grey level to be displayed on the associated column electrode. The selection means 47 may be combinatorial logic circuits which use q (q≧1) higher order bits of the words encoding the information to be displayed, present at the output of the associated assembly 41 of memory latches.

The composition of the first processing chain 30 will now be described. This first processing chain 30 includes in a cascade, means 32 for delivering from information relative to the grey level to be displayed, which they receive, a signal which, if of course the control should be performed by pulsed width modulation, expresses the beginning or the end of a pulse-width-modulated voltage pulse.

These means 32 are connected via logic matching means 45 to an input of an output stage 53 connected to the associated column electrode. This output stage 53, common to both processing chains 30, 31, is formed with three switches Q1, Q2, Q3, a single one of which may be closed at a time.

Among these three switches Q1, Q2, Q3, two switches Q1, Q2 cooperate with the first processing chain 30 and the third Q3 with the second processing chain 31. These switches Q1, Q2, Q3 may be transistors as illustrated in FIGS. 8B and 9. This output stage 53 is capable of delivering the pulse-width-modulated signal to be applied to the associated column electrode.

The two transistors Q1 and Q2 which cooperate with the first processing chain 30 are mounted in a push-pull configuration between the extreme voltage Vc and the reference voltage Vcom respectively. With the transistor Q1, the voltage Vc may be switched over to the associated column electrode while the reference voltage Vcom may be imposed with the transistor Q2.

The means 32 for delivering the signal expressing the beginning or the end of the pulse-width-modulated voltage pulse may include a comparator 43 receiving on s first inputs, the output of s memory latches of the assembly 41 to which it is connected and on s second inputs the result of a count achieved with a cyclic counter 42, clocked by a CCP clock and reset by a load signal LC warning of the beginning of each new line selection period. The counter 42 counts from 0 to 2^{s}−1 during the line selection period T1. It may be contemplated that the means 32 for delivering the signal expressing the beginning or the end of the pulse-width-modulated voltage pulse do not receive all the bits of the words encoding the grey levels, but only those which are significant as this will be seen later on.

The comparator 43 compares the information relative to the grey level and the result of the count achieved by the cyclic counter 42 counting a number of clock pulses CCP determined by the size of the information relative to the grey level, during the line selection period.

In the first processing chain 30, the comparator 43 therefore changes state at a given instant which corresponds to the moment when the result of the counting of the cyclic counter 42 coincides with the data present on the s first inputs of the comparator 43. The means 32 for delivering the signal expressing the beginning or the end of the pulse-width-modulated signal pulse also include a flip-flop 44 connected to the output of the comparator 43. This flip-flop 44 also receives at the input the load signal LC. This flip-flop 44 switches as soon as the signals arriving on both of its inputs have changed. The flip-flop 44 connected at the output of the comparator 43 also receives a cue at the beginning of each line selection period and delivers the signal expressing the beginning or end instant of the pulse-width-modulated voltage pulse.

The output of the flip-flop 44 is connected to the transistors Q1, Q2 of the output stage 53 at their control gate, via logic level matching means 45.

The output stage 53 is capable of switching, depending on the signal which is received from the flip-flop 44, either the reference voltage Vcom (transistor Q2 is conducting and transistor Q1 is blocked), or the extreme voltage Vc positive relatively to the reference voltage (transistor Q1 is conducting and transistor Q2 is blocked), or none of these two voltages depending on the validation delivered by the selection means 47. In the latter possibility, it is the first transistor Q3 of the output stage which is conducting and both transistors Q1 and Q2 are blocked.

The logic level matching means 45 translate the amplitude of the signal expressing the beginning or end instant of the pulse-width-modulated voltage pulse, which is a logic signal for obtaining a signal for which the amplitude is suitable for controlling the transistors Q1 and Q2 respectively. They are connected at the input to the output of the selection means 47.

The selection means 47, achieved by means of a combinatorial circuit, either allow or not the switching of the transistors Q1, Q2 of the first processing chain if the q high order bits of the data delivered by the associated assembly 41 of memory latches correspond to the darkest grey level. In the example of FIG. 7, q=1 would be assumed for example and the output stage 53 may switch between Vcom and Vc, by the means of the signals applied to the gates of the transistors Q1, Q2, originating from the output of the flip-flop 44 if the high order bit q has the value 0.

Since there are m first processing chains 30, provision may therefore be made for m comparators 43, a single counter 42 for these m processing chains, m flip-flops 44, m logic level matching means 45 and these logic level matching means are connected to m output stages 53.

The composition of the second processing chain 31 will now be described. This second processing chain 31 includes in a cascade, means 33 for delivering from information relative to the grey level which they receive, a signal which, if of course the control should be performed by amplitude modulation, expresses a sample & hold instant of the ramp generator 24 with a negative slope. These means 33 drive analog memory storage means 51. The analog memory storage means 51 have their output connected to the input of a buffer amplifier 52, the output of which is connected to the associated column electrode via the switch Q3 of the output stage 53. This switch Q3 embodied in the example by a transistor has already been mentioned. The transistor Q3 is mounted between the associated column electrode and the output of the buffer amplifier 52. The buffer amplifier 52 is capable of delivering the amplitude-modulated voltage to the associated column electrode when it is validated by the transistor Q3 which is then conducting.

The means 33 for delivering the signal expressing the sample & hold instant, may include as for the first processing chain 30, a comparator 49 receiving on s first inputs, the outputs of the s memory latches of the assembly 41 to which it is connected and on s second inputs, the result of a count achieved by a cyclic counter 48, clocked by a clock CCN and reset by the load signal LC. It may be contemplated that the means 33 for delivering the signal expressing the sample & hold instant do not receive all the bits of the words encoding the grey levels, but only those which are significant as this will be seen later on.

The comparator 49 compares the information relative to the grey level and the result of a count achieved by the cyclic counter 48 counting a number of clock pulses CCN determined by the size of the information relative to the grey level, during the line selection period.

In the second processing chain 31, the comparator 49 therefore changes state at a given instant which corresponds to the moment when the result of the count of the counter 48 coincides with the data present on the s first inputs of the comparator 49. The means 33 for delivering the signal expressing the sample & hold instant also include a flip-flop 50, connected to the output of the comparator 49. This flip-flop 50 receives at the input, the load signal LC and the output of the comparator 49. This flip-flop 50 switches as soon as the signals arriving on both of its inputs have changed. The flip-flop 50 is connected at the output to the input of the analog memory storage means 51, the output of which is connected to the input of the buffer amplifier 52. The analog memory storage means 51 include a storage capacitor, a terminal of which is connected to the output of the ramp generator (materialized by the designation VR) via a switch 11. This terminal is also connected to the input of the buffer amplifier 52. The other terminal of the capacitor C1 is set to a reference voltage, generally the ground. This reference voltage may be different from Vcom. The switch 11 is controlled by the output of the flip-flop 50. With the opening of the switch 11 the voltage level delivered by the ramp generator 24 just before the opening, may be stored in the capacitor C1. The buffer amplifier 52 may be made with an amplifier capable of recopying the voltage delivered by the analog memory storage means 51. If the transistor Q3 is conducting, it delivers the current to the control of the associated column electrode. The conducting or blocked state of the transistor Q3 is controlled by logic level matching means 46 mounted between the gate of the transistor Q3 and the output of the selection means 47. The logic level matching means 46, connected to the gate of the transistor Q3, translate the logic signal from the selection means 47 into a signal, the amplitude of which is suitable for controlling the transistor Q3. The selection means 47 allow the switching, on the associated column electrode, of the voltage from the buffer amplifier 52 in the way which has been described earlier for the first processing chain 30, but now the q high order bits of the words encoding the information delivered by the associated memory latch 41 should correspond to the least dark grey levels. In the example of FIG. 7, the buffer amplifier 52 of the second processing chain 31 will be validated if the high order q has the value 1. The buffer amplifier 52 when it is enabled by the transistor Q3 delivers the amplitude-modulated voltage to the associated column electrode.

Since they are m second processing chains 31, provision may therefore be made for m comparators 49, a single counter 48 for these m processing chains, m flip-flops 50, m switching assemblies 51, capacitors C1 and m buffer amplifiers 52 connected to m transistors Q3 of m output stages 53.

Thus, for a word encoding a dark grey level of the first family of grey levels, a counter 43 and comparator 42 assembly allows adjustment of the switching time of the reference voltage Vcom or conversely of the switching time of the positive extreme voltage Vc. For a word encoding a paler grey level of the second family of grey levels, a counter 48 and comparator 49 assembly allows selection of the moment of the opening of the switch I1 and thus storage in memory of the voltage level Vc(k) negative relative to the reference voltage Vcom.

FIG. 8B is only an exemplary embodiment of the control of the column electrodes of the viewing device.

It is possible that the counter 42 associated with the first processing chains 30 and the counter 48 associated with the second processing chains 31 coincide, which simplifies the circuit of FIG. 8B. This requires that both CCP and CCN also coincide. However this alternative limits the possibilities of adjusting the grey level response curve. FIG. 9 schematically gives such a configuration for the first and the second processing chain associated with the column electrode C1. The common counter is referenced as 60 and the clock as CK.

Another possible simplification in the case when the separation between both families of grey levels is performed on only one high order bit such as in the example described in FIG. 7, is that the counter-comparator 60, 43, 49 assemblies only handle low order bits s−q of the encoded words. This provides a gain in processing time. This alternative is illustrated in FIG. 9.

Although several embodiments of the present invention have been illustrated and described in detail, it will be understood that different changes and modifications may be provided without departing from the scope of the invention.

### CITED DOCUMENTS

[1]<<Ecrans fluorescents à micropointes>>, R. Baptist, l'Onde Electrique, November-December 1991, vol. 71, No. 6, pages 36-42.
[2]<<Flat panel displays based on surface-conduction electron emitters>>, K. Sakai et al., Proceedings on the 16^{th} International Display Research Conference, ref. 18.3L., pages 569-572.
[3]<<Carbon nanotube FED elements>>, S. Uemura et al. Digest, pages 1052-1055.
[4] EP-A-0 316 214.
[5]<<Microtips addressing>>, T. Leroux et al. SID1991 Digest, pages 437-439.
[6]<<6-in Video CNT-FED with improved uniformity>> J. Dijon et al. IDW 2005, pages 1-4.
[7] EP-A-0 635 819.
[8] FR-A-2 832 537.

1-22. (canceled)

23. A method for driving a matrix viewing device displaying grey levels, comprising at least one source of electrons (Pi,j) located at the crossing of a line electrode (Li) and a column electrode (Cj), consisting of applying a line selection voltage (Vls) when the line electrode (Li) on which is found the source of electrons (Pi,j) is selected, and a line non-selection voltage (Vlns) when it is not selected, and of applying onto the corresponding column electrode (Cj) a control voltage corresponding to the grey level to be displayed, during a line selection period (T1),
characterized in that the grey levels to be displayed are distributed into two families (F1, F2) of grey levels, the first (F1) grouping one or more of the darkest grey levels, the second (F2) grouping one or more of the least dark grey levels,
and in that, if the grey level to be displayed belongs to the first family (F1), the control voltage to be applied is a pulse-width-modulated voltage varying between a reference voltage (Vcom) and an extreme voltage (Vc), the direction of variation between the reference voltage and the extreme voltage being the same as between the line non-selection voltage and the line selection voltage,
and in that if the grey level to be displayed belongs to the second family (52), the control voltage to be applied is an amplitude-modulated voltage varying between the reference voltage (Vcom) and a maximum voltage (Vc(k3)), the direction of variation between the reference voltage and the maximum voltage being opposite to that existing between the line non-selection voltage (Vlns) and the line selection voltage (Vls),
the extreme voltage and the maximum voltage being reduced relatively to those which would be required if the control was performed for all the grey levels by amplitude modulation or by pulse width modulation.

24. The method according to claim 23, characterized in that the extreme voltage (Vc) is positive relative to the reference voltage (Vcom) and in that the maximum voltage (Vc(k3)) is negative relative to the reference voltage (Vcom).

25. The method according to claim 23, wherein:
if the grey level to be displayed belongs to the first family (F1), the control voltage during a first time interval (T, 0<T≦T1), is the extreme voltage (Vc) which is constant and, insofar that the first time interval (T) is strictly less than the line selection period (T1), the control voltage during a second time interval (T′=T1−T) preceding or following the first time interval (T), is the reference voltage (Vcom), the value of the first time interval T depending on the grey level to be displayed and,
if the grey level to be displayed belongs to the second family (F2), the control voltage during the whole line selection period (T1), is a constant voltage negative relative to the reference voltage (Vcom) or equal to the reference voltage, this control voltage having an amplitude which depends on the grey level to be displayed.

26. The method according to claim 23, characterized in that the line selection voltage (Vls) is constant during the whole line selection period (T1).

27. The method according to claim 23, characterized in that if several sources of electrons are on a same line electrode (Li), it consists of simultaneously applying a control voltage (Vc) on each of the column electrodes (C1, Cj, Cm) relative to these sources of electrons.

28. The method according to claim 23, characterized in that it consists of applying the line non-selection voltage (Vlns), during the whole line selection period (T1), to a non-selected line electrode (Li+1).

29. The method according to claim 23, characterized in that the extreme voltage (Vc) and the maximum voltage (Vc(k3)) are substantially equal in absolute value.

30. The method according to claim 23, characterized in that the reference voltage (Vcom) corresponds to the ground.

31. A viewing device driven by the control method according to claim 23, wherein the source of electrons (4) includes a resistor (R1) between an electron emitting area (4) and a cathode electrode (3) electrically connected to the line electrode.

32. A device for driving a matrix viewing device displaying grey levels, comprising at least one source of electrons located at the crossing of a line electrode (Li) and of a column electrode (Cj) of an assembly including one or more line electrodes and one or more column electrodes, including a line sweep generator (22) for applying a line selection voltage (Vls) during a line selection period (T1), when the line electrode (Li) on which is found the source of electrons, is selected, and a line non-selection voltage (Vlns) when it is not selected,
and a column control circuit (23) capable of applying on the corresponding column electrode (Cj), a control voltage corresponding to the grey level to be displayed, during the line selection period,
characterized in that the circuit for controlling the columns (23) includes, for each column electrode of the assembly,
a first processing chain (30) for delivering a pulse-width-modulated control voltage to be applied to the column electrode if the grey level belongs to a first family (F1) of grey levels containing one or more of the darkest grey levels, the pulse-width-modulated control voltage varying between a reference voltage (Vcom) and an extreme voltage (Vc), the direction of variation between the reference voltage (Vcom) and the extreme voltage (Vc) being the same as that between the line non-selection voltage (Vlns) and the line selection voltage (Vls), and
a second processing chain (31) for delivering an amplitude-modulated control voltage to be applied on the column electrode (Cj), if the grey level belongs to a second family (F2) of grey levels containing one or more of the least dark grey levels, the amplitude-modulated control voltage varying between the reference voltage (Vcom) and a maximum voltage (Vc(k3)), the direction of variation of the reference voltage (Vcom) and the maximum voltage (Vc(k3)) being opposite to that existing between the line non-selection voltage (Vlns) and the line selection voltage (Vls),
the extreme voltage (Vc) and the maximum voltage (Vc(k3)) being reduced relatively to those which would be required if the control was performed for all the grey levels by amplitude modulation or pulse width modulation.

33. The device according to claim 32, characterized in that the extreme voltage (Vc) is positive relative to the reference voltage (Vcom) and in that the maximum voltage (Vc(k3)) is negative relative to the reference voltage (Vcom).

34. The device according to claim 32, characterized in that the first processing chain (30) includes means (32) for delivering, from information encoding the grey level to be displayed which they receive, a signal which expresses an instant of the beginning or end of the pulse-width-modulated voltage pulse in the line selection period (T1), if the grey level belongs to the first family (F1) of grey levels, these means (32) being connected via logic level matching means (45) to an output stage (53) capable of delivering the pulse-width-modulated voltage.

35. The device according to claim 34, characterized in that the means (32) for delivering the signal expressing the instant of the beginning or end of the pulse-width-modulated voltage pulse include a comparator (43) comparing the information encoding the grey level and the result of a count achieved by a cyclic counter (42) counting a number of clock pulses (CCP) determined by the size of the information encoding the grey level, during the line selection period (T1), and a flip-flop (44) connected to the output of the comparator (43) and also receiving a cue (LC) at the beginning of each line selection period (T1) and delivering the signal expressing the instant of the beginning or end of the pulse-width-modulated voltage pulse.

36. The device according to claim 32, characterized in that it includes a negative ramp generator (24) with which the amplitude-modulated voltage may be provided and in that the second processing chain (31) includes means (33) for delivering, from information encoding the grey level which they receive, a signal which expresses a sample & hold instant of the negative ramp generator (24) in a line selection period (T1), if the grey level belongs to the second family (F2) of grey levels, these means (33) controlling analog memory storage means (51) having an input connected to the negative ramp generator (24) and an output connected to the input of a buffer amplifier (52) capable of delivering the amplitude-modulated voltage.

37. The device according to claim 36, characterized in that the means (33) for delivering the signal expressing the sample & hold instant of the negative ramp generator (24) include a comparator (49) comparing the information encoding the grey level and the result of a count achieved by a cyclic counter (48) counting a number of clock pulses (CCN) determined by the size of the information encoding the grey level, during the line selection period (T1) and a flip-flop (50) connected to the output of the comparator (49) and also receiving a cue (LC) at the beginning of each line selection period (T1) and delivering the signal expressing the sample & hold instant of the negative ramp generator (24).

38. The device according to claim 35, characterized in that the cyclic counter (60) is common to the first and to the second processing chain.

39. The device according to claim 36, characterized in that the analog memory storage means (51) include a switch (I1) connected on one side to the negative ramp generator (24) and on the other side to a terminal of a capacitor (C1) itself connected to the input of the buffer amplifier (52), the other terminal of the capacitor (C1) being set to a reference voltage, this switch (I1) being controlled by the signal expressing the sample & hold instant of the negative ramp generator (24).

40. The device according to claim 39, characterized in that the reference voltage to which the other terminal of the capacitor (C1) is set, is the ground.

41. The device according to claim 32, characterized in that the column control circuit further includes, per column electrode (C1), means (47) for selecting the first processing chain (30) or the second processing chain (31) depending on the grey level to be displayed on the column electrode (C1).

42. The device according to claim 41, characterized in that the grey level to be displayed is encoded as a binary word with one or more high order bits (q), the selection means (47) being combinatorial circuits receiving the high order bits (q) of the binary word.

43. The device according to claim 32, characterized in that the circuit for controlling the columns further includes a shift register (40) which drives as many assemblies (41) of memory latches as there are column electrodes (C1, Cm), each assembly (41) of memory latches receiving at the input the grey levels to be displayed by the viewing device and being connected to a first processing chain (30) and to a second processing chain (31).

44. The device according to claim 43, characterized in that the column control circuit further includes, per column electrode (C1), means (47) for selecting the first processing chain (30) or the second processing chain (31) depending on the grey level to be displayed on the column electrode (C1), each assembly (41) of memory latches being also connected at the output to the input of the selection means (47).
